(19) United States
(12) Patent Application Publication
(10) Pub. No.: US 2026/0199956 A1
(43) Pub. Date: Jul. 16, 2026

(54) CORRUGATED PLATE, FLOW PATH PLATE, AND CORRUGATED PLATE MANUFACTURING DEVICE

(71) Applicant: AISIN CORPORATION, Kariya (JP)

(72) Inventors: Satoru ITO, Kariya-shi (JP); Miki Hoshino, Kariya-shi (JP); Koji Sugawara, Kariya-shi (JP); Takafumi Hayashi, Kariya-shi (JP); Akira Taoka, Kariya-shi (JP); Norimichi Ebisawa, Yokohama-shi (JP); Daisuke Suzuki, Ashigarashimogun (JP); Takehiro Fukada, Fujisawa-shi (JP); Motoyoshi Ishii, Yokohama-shi (JP)

(73) Assignee: AISIN CORPORATION, Kariya (JP)

(21) Appl. No.: 19/394,127

(22) Filed: Nov. 19, 2025

(30) Foreign Application Priority Data
Jan. 16, 2025 (JP) 2025-006259

(51) Int. Cl. B21D 53/00; B21D 13/04

(52) U.S. Cl. CPC B21D 53/00; B21D 13/04

(57) ABSTRACT

A corrugated plate includes a film portion formed on at least one surface of a flat plate, a plurality of ridge portions formed on the flat plate on which the film portion is formed, a scratch formed in a direction intersecting a longitudinal direction of the ridge portions, and a connection portion formed between two of the adjacent ridge portions. The scratch is formed on the ridge portion and is not formed on the connection portion.

### CROSS REFERENCE TO RELATED APPLICATIONS

This application is based on and claims priority under 35 U.S.C. § 119 to Japanese Patent Application 2025-006259, filed on Jan. 16, 2025, the entire content of which is incorporated herein by reference.

### TECHNICAL FIELD

This disclosure relates to a corrugated plate having a film portion formed on at least one surface of a flat plate, a plurality of ridge portions formed on the flat plate on which the film portion is formed, and a connection portion formed between two of the adjacent ridge portions.

### BACKGROUND DISCUSSION

JP 2013-71130A discloses a corrugated plate manufactured by corrugating a flat plate using a pair of gears.

When a film portion is formed on a surface layer of a workpiece, there is a problem that the film portion is scraped due to friction between gears during rotation at the time of corrugating, and a function of the film portion deteriorates.

In order to solve the problems in the related art, an object of this disclosure is to prevent functional deterioration of a film portion formed on a surface layer of a workpiece.

### SUMMARY

According to an aspect of this disclosure, a corrugated plate includes a film portion formed on at least one surface of a flat plate, a plurality of ridge portions formed on the flat plate on which the film portion is formed, a scratch formed in a direction intersecting a longitudinal direction of the ridge portions, and a connection portion formed between two of the adjacent ridge portions. The scratch is formed on the ridge portion and is not formed on the connection portion.

According to another aspect of this disclosure, a flow path plate is formed by stacking a sheet on the corrugated plate.

According to still another aspect of this disclosure, a corrugated plate manufacturing device includes a first roller and a second roller that feed a band-like flat plate in a first direction and form ridge portions extending in a second direction intersecting the first direction, a drive unit configured to rotate the first roller and the second roller, and a control unit configured to adjust a mesh interval between the first roller and the second roller, in which a non-contact portion that does not come into contact with the flat plate during manufacturing a corrugated plate is provided between a tooth tip portion and a tooth root portion of each of the first roller and the second roller.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view showing a corrugated plate manufacturing device according to an embodiment;

FIG. 2 is a cross-sectional view taken along a line II-II in FIG. 1;

FIG. 3 is a schematic view showing a first sub-gear and two second sub-gears of a transmission mechanism;

FIG. 4 is an enlarged view showing a pair of gears provided in the corrugated plate manufacturing device in FIG. 1;

FIG. 5 is a schematic view showing a fine water particle generation polymer film;

FIG. 6 is a schematic view showing particles having a core-shell structure and constituting the fine water particle generation polymer film;

FIG. 7 is a schematic view when a corrugated plate is manufactured by a pair of gears provided in a corrugated plate manufacturing device in the related art;

FIG. 8 is a view showing a corrugated plate manufactured by the pair of gears in FIG. 7;

FIG. 9 is a schematic view showing a corrugated plate manufactured by the pair of gears in FIG. 4;

FIG. 10 is a view showing a corrugated plate manufactured by the pair of gears in FIG. 9;

FIG. 11 is a schematic view when one of the pair of gears is rotated by rotation of the other one;

FIG. 12 is a view showing a corrugated plate manufactured by the pair of gears in FIG. 11;

FIG. 13 is a view showing a corrugated plate manufactured by the pair of gears in FIG. 4;

FIG. 14 is a schematic view showing a corrugated plate to which an insulating film is attached; and

FIG. 15 is a schematic view showing a humidity control cartridge.

### DETAILED DESCRIPTION

Hereinafter, a corrugated plate manufacturing device for manufacturing a corrugated plate according to an embodiment disclosed here will be described in detail with reference to the drawings.

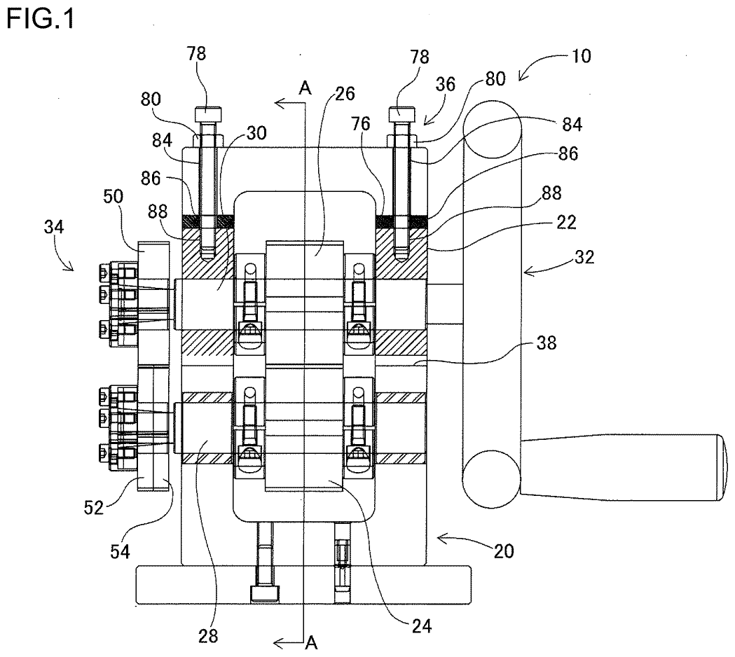

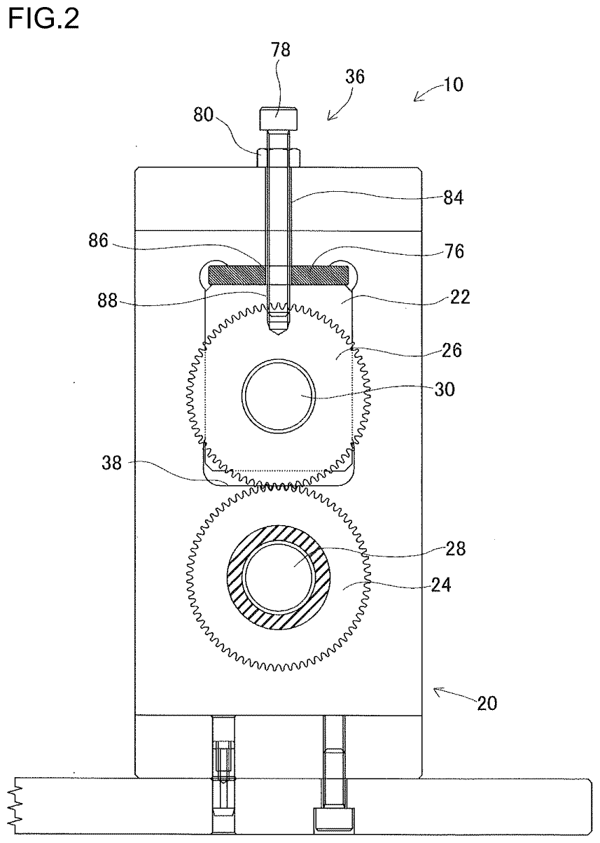

A corrugated plate manufacturing device 10 is a device that manufactures a wave plate, that is, a so-called corrugated plate by corrugating a flat plate. As shown in FIGS. 1 and 2, the corrugated plate manufacturing device 10 includes a device main body 20, a slide block 22, a pair of gears 24 and 26, a pair of support shafts 28 and 30, a handle 32, a transmission mechanism 34, and an adjustment mechanism 36. FIG. 1 is a cross-sectional view showing the corrugated plate manufacturing device 10 viewed from a horizontal direction orthogonal to a rotation axis of the gears 24 and 26, and FIG. 2 is a cross-sectional view taken along a line II-II in FIG. 1.

The device main body 20 serves as a base of the corrugated plate manufacturing device 10 and has a substantially block shape. The device main body 20 holds the support shaft 28 such that the support shaft 28 is rotatable about an axis, and the gear 24 is coaxially fixed to a central portion of the support shaft 28 in an axial direction. A space 38 larger than an outer dimension of the slide block 22 is formed above the support shaft 28 of the device main body 20, and extends in the axial direction of the support shaft 28. The slide block 22 is inserted into the space 38. An inner dimension of the space 38 in a left-right direction is slightly larger than the outer dimension of the slide block 22 in the left-right direction, and the inner dimension of the space 38 in an upper-lower direction is larger than the outer dimension of the slide block 22 in the upper-lower direction by a predetermined length. Therefore, the slide block 22 slides in the upper-lower direction inside the space 38. That is, the device main body 20 holds the slide block 22 inside the space 38 such that the slide block 22 can slide in the space 38 by a predetermined length in the upper-lower direction.

The slide block 22 holds the support shaft 30 such that the support shaft 30 is rotatable about an axis, and the support shaft 30 is disposed above the support shaft 28 such that the axis of the support shaft 30 is parallel to the axis of the support shaft 28. The gear 26 is coaxially fixed to a central portion of the support shaft 30 in an axial direction, and the gear 26 meshes with the gear 24. The gear 24 and the gear 26 have the same shape. The handle 32 is fixed to an end portion of the support shaft 30, and the support shaft 30 is rotated by the rotation of the handle 32.

The transmission mechanism 34 transmits the rotation of the support shaft 30 to the support shaft 28, and the support shaft 28 is rotated when a drive force of the handle 32 is transmitted to the support shaft 28 via the support shaft 30 and the transmission mechanism 34. Specifically, the transmission mechanism 34 includes a first sub-gear 50 and two second sub-gears 52 and 54. The first sub-gear 50 is coaxially fixed to an end portion of the support shaft 30 opposite to the end portion to which the handle 32 is fixed. On the other hand, the two second sub-gears 52 and 54 are coaxially fixed to an end portion of the support shaft 28 below the first sub-gear 50. The two second sub-gears 52 and 54 are fixed to the end portion of the support shaft 28 in a state in which phases of the second sub-gears 52 and 54 are slightly shifted from each other. The two second sub-gears 52 and 54 have the same shape.

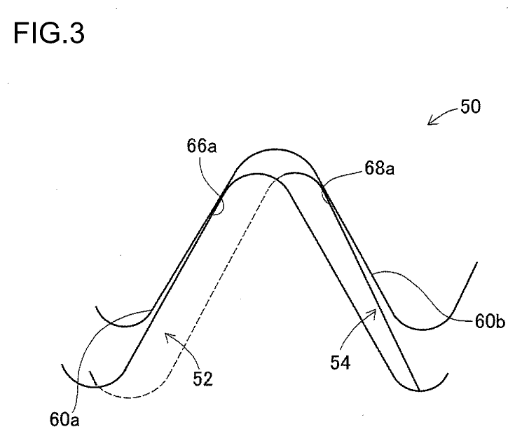

Specifically, as shown in FIG. 3, one tooth 66a of a plurality of teeth 66 formed on an outer peripheral surface of the second sub-gear 52 enters between two adjacent teeth 60a and 60b of a plurality of teeth 60 formed on an outer peripheral surface of the first sub-gear 50, and the first sub-gear 50 and the second sub-gear 52 mesh with each other. The first sub-gear 50 and the second sub-gear 52 mesh with each other in a state in which one tooth 66a of the second sub-gear 52 that entered between the two teeth 60a and 60b of the first sub-gear 50 comes into contact with one tooth 60a of the two teeth 60a and 60b of the first sub-gear 50. One tooth 68a of a plurality of teeth 68 of the second sub-gear 54 enters between the two teeth 60a and 60b of the first sub-gear 50, and the first sub-gear 50 and the second sub-gear 54 also mesh with each other. The first sub-gear 50 and the second sub-gear 54 mesh with each other in a state in which one tooth 68a of the second sub-gear 54 that entered between the two teeth 60a and 60b of the first sub-gear 50 comes into contact with the other tooth 60b of the two teeth 60a and 60b of the first sub-gear 50.

In this manner, since the first sub-gear 50 and the second sub-gear 52 mesh with each other and the first sub-gear 50 and the second sub-gear 54 mesh with each other, when the support shaft 30 is rotated by the rotation of the handle 32, a rotational force of the first sub-gear 50 is transmitted to the two second sub-gears 52 and 54, and the two second sub-gears 52 and 54 rotate without rattling. That is, when the first sub-gear 50 rotates, the teeth 66a of the second sub-gear 52 comes into contact with the one tooth 60a of the two teeth 60a and 60b of the first sub-gear 50, and the teeth 68a of the second sub-gear 54 comes into contact with the other tooth 60b of the two teeth 60a and 60b of the first sub-gear 50, so that the first sub-gear 50 and the two second sub-gears 52 and 54 rotate without rattling. Therefore, the support shaft 30 that rotates the first sub-gear 50 and the support shaft 28 to which the two second sub-gears 52 and 54 are fixed rotate in synchronization with each other. As described above, the support shaft 28 and the support shaft 30 rotate in synchronization with each other, so that the gear 24 fixed to the support shaft 28 and the gear 26 fixed to the support shaft 30 rotate in a state of meshing with each other.

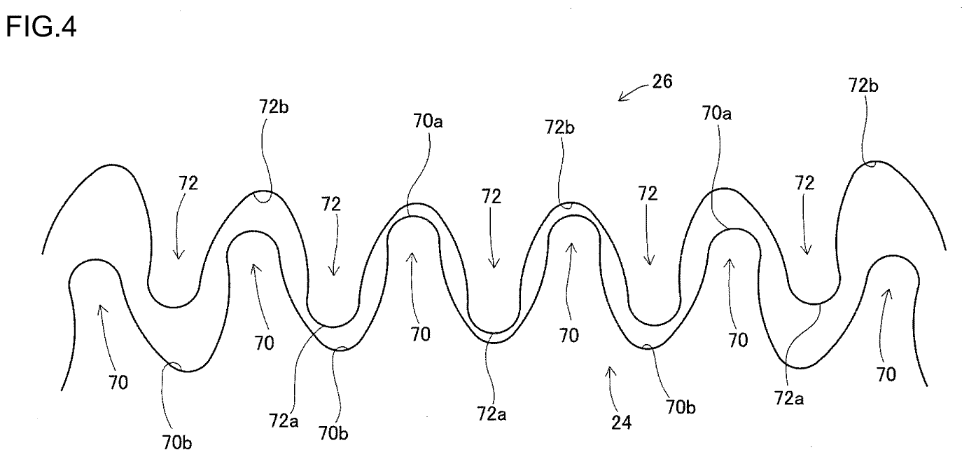

As shown in FIG. 4, the gear 24 is fixed to the support shaft 28 and the gear 26 is fixed to the support shaft 30 so that a plurality of teeth 70 formed on an outer peripheral surface of the gear 24 and a plurality of teeth 72 formed on an outer peripheral surface of the gear 26 do not come into contact with each other in a state in which the gear 24 and the gear 26 mesh with each other. Therefore, when the support shaft 28 and the support shaft 30 rotate in synchronization with each other and the gear 24 and the gear 26 rotate in a state of meshing with each other, the teeth 70 of the gear 24 and the teeth 72 of the gear 26 do not come into contact with each other.

The adjustment mechanism 36 adjusts a distance between the teeth 70 of the gear 24 and the teeth 72 of the gear 26, specifically, a distance between a tooth tip 70a of the gear 24 and a tooth root 72b of the gear 26, and a distance between a tooth root 70b of the gear 24 and a tooth tip 72a of the gear 26 (hereinafter referred to as an “inter-gear distance”). As shown in FIGS. 1 and 2, the adjustment mechanism 36 includes a spacer 76, two adjustment screws 78, and two nuts 80. The spacer 76 has a plate shape having substantially the same dimension as an upper surface of the slide block 22, and is disposed on an upper surface of the slide block 22 inside the space 38 of the device main body 20.

Two through holes 84 are formed from an upper surface of the device main body 20 to the space 38, and an inner diameter of the through hole 84 is slightly larger than an outer diameter of the adjustment screw 78. Two through holes 86 are formed in the spacer 76, and an inner diameter of the through hole 86 is the same as the inner diameter of the through hole 84. The two through holes 84 and the two through holes 86 communicate with each other. Two screw holes 88 are formed in an upper surface of the slide block 22, and the two screw holes 88 communicate with the two through holes 86. The two adjustment screws 78 are respectively inserted into the two through holes 84 and the two through holes 86 and screwed into the two screw holes 88. Further, the two nuts 80 are respectively screwed to the two adjustment screws 78 on the upper surface of the device main body 20.

Therefore, in the adjustment mechanism 36, when the adjustment screw 78 is screwed into the screw hole 88, the slide block 22 slides upward inside the space 38 of the device main body 20, and the upper surface of the slide block 22 comes into close contact with the spacer 76. Then, the adjustment screw 78 is fixed by screwing the nut 80 toward the upper surface of the device main body 20. Accordingly, the inter-gear distance is a distance corresponding to a thickness dimension of the spacer 76. A spacer having a thickness dimension different from that of the spacer 76 is prepared, and the inter-gear distance can be changed by replacing the spacer 76 disposed on the upper surface of the slide block 22 with another spacer. Therefore, in the adjustment mechanism 36, the inter-gear distance can be adjusted by replacing the spacer with a spacer having a different thickness dimension.

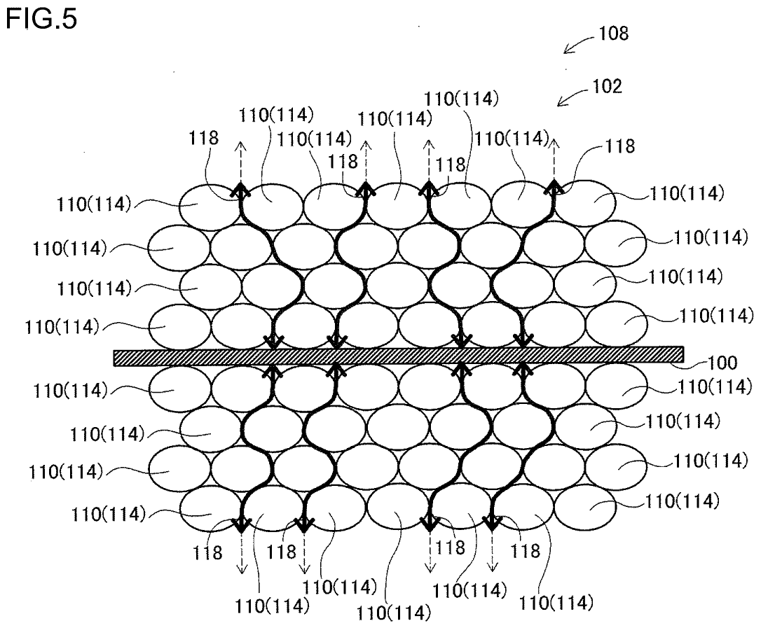

In the corrugated plate manufacturing device 10 having such a structure, a flat plate enters between the pair of gears 24 and 26, and the handle 32 is rotated, so that a corrugated plate can be manufactured by corrugating the flat plate. In the following description, as shown in FIG. 5, a corrugated plate manufacturing device 10 corrugates a film forming stainless steel plate 108 on which a fine water particle generation polymer film 102 is formed on both surfaces of the flat plate-shaped stainless steel plate 100. The fine water particle generation polymer film 102 is a film that generates fine water particles having a diameter of several nanometers (hereinafter, referred to as fine water particles), and the fine water particle generation polymer film 102 will be described below.

As shown in FIG. 5, the fine water particle generation polymer film 102 is formed in a sheet shape and is in close contact with both surfaces of the flat plate-shaped stainless steel plate 100. Instead of the stainless steel plate 100, a flat plate made of any material among a copper-based metal material, a carbon material (carbon paper, graphite, or the like), a conductive ceramic material (for example, ITO), and a conductive resin material (for example, a metal-deposited film, nano-silver coating, and CNT coating), which are conductive materials, can be adopted. The stainless steel plate 100 or a flat plate made of another conductive material generates heat when the plate is energized.

The fine water particle generation polymer film 102 is formed by dispersing particles 110 having a core-shell structure in a solvent, applying a dispersion liquid in which the particles 110 are dispersed to both surfaces of the stainless steel plate 100, and then drying the dispersion liquid. That is, the fine water particle generation polymer film 102 is manufactured by a manufacturing method including an application step of applying a dispersion liquid in which the particles 110 are dispersed to the stainless steel plate 100 having conductivity, and a drying step of drying the particles 110 applied to the stainless steel plate 100 after the application step. By this manufacturing method, as conceptually shown in FIG. 5, a plurality of the particles 110 are formed in a sheet shape (film shape) by being stacked in a plurality of stages in a close-packed structure with a certain degree of regularity. The solvent of the dispersion liquid is, for example, water.

The particles 110 transition from a released state to an adsorption state as a temperature of the fine water particle generation polymer film 102 decreases toward the room temperature in a non-energized state of the stainless steel plate 100, and transition from the adsorption state to the released state as the temperature of the fine water particle generation polymer film 102 increases from the room temperature in an energized state of the stainless steel plate 100. A particle diameter of the particle 110 in the present embodiment is set to about 1 nanometer to 500 nanometers. Accordingly, the plurality of particles 110 are closely stacked on an outer surface of the stainless steel plate 100 to form the fine water particle generation polymer film 102. The fine water particle generation polymer film 102 is formed such that a thickness (film thickness) when the plurality of particles 110 are stacked on the outer surface of the stainless steel plate 100 is 1μm to 30 μm. The particles 110 in the present embodiment are formed of PEDOT/PSS (poly (3,4-ethylenedioxythiophene)-poly (styrene sulfonic acid)).

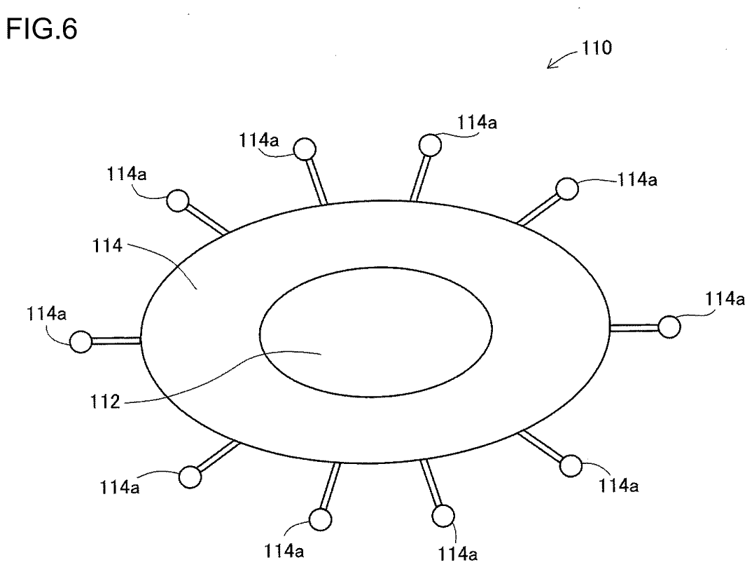

As shown in FIG. 6, the particle 110 includes a core 112 and a shell 114. The core 112 of the particle 110 forms a nucleus of the particle, and is formed of poly (3,4-ethylenedioxythiophene), that is, PEDOT. The shell 114 of the particle 110 is formed of poly (styrene sulfonic acid), that is, PSS as a polymer material having a hydrogen bondable sulfonic acid group (—SO₃H) 114a, and covers the core 112.

With such a structure, when the stainless steel plate 100 is in a non-energized state, an amount of moisture adsorbed by the shell 114 of the particle 110 increases as time elapses, and the fine water particle generation polymer film 102 is stable in a state of a saturated moisture absorption rate. On the other hand, when the stainless steel plate 100 is energized and the temperature of the particle 110 increases, the fine water particle generation polymer film 102 releases the moisture adsorbed on the shell 114 of the particle 110 in the form of water particles.

In the fine water particle generation polymer film 102 including the particles 110 having the core-shell structure, an adsorption speed of moisture in the air in the adsorption state and a release speed of moisture in the air in the released state are faster than those of a general moisture absorbent such as silica gel. In the fine water particle generation polymer film 102 including the particles 110 having a core-shell structure, a size of a water particle of moisture released in the released state is distributed in a very small particle diameter distribution range of about 1 nanometer to 40 nanometers, more specifically, 1 nanometer to 10 nanometers.

Specifically, first, the adsorption speed and the release speed of moisture will be described. In the fine water particle generation polymer film 102, the particles 110 formed of PEDOT/PSS are stacked on the stainless steel plate 100. In this case, as shown in FIG. 5, the shells 114 of the particles 110 are stacked in an aligned state in the fine water particle generation polymer film 102. As shown in FIG. 6, the PSS constituting the shell 114 of the particle 110 has a large number of the sulfonic acid groups (—SO₃H) 114a, which are hydrogen bondable polar functional groups, on the outer peripheral surface of the shell 114. Therefore, the sulfonic acid group 114a in contact with the air adsorbs moisture contained in the air by hydrogen bonding.

At this time, when an amount of moisture on a surface of the fine water particle generation polymer film 102 is large and an amount of moisture inside the fine water particle generation polymer film 102 is small, the shell 114 of the particle 110 attempts to move the adsorbed moisture from the surface of the fine water particle generation polymer film 102 toward the inside of the fine water particle generation polymer film 102 using a moisture concentration difference as a drive source. As indicated by thick arrows in FIG. 5, nanometer-sized flow paths 118 (hereinafter referred to as “nano-channels 118”) are formed between the plurality of stacked particles 110 inside the fine water particle generation polymer film 102. A large number of the sulfonic acid groups 114a are distributed in the nano-channels 118, and moisture adsorbed on the surface of the fine water particle generation polymer film 102 are moved to the inside of the fine water particle generation polymer film 102 at high speed by the sulfonic acid groups 114a present in the nano-channels 118. That is, the moisture adsorbed on the surface of the fine water particle generation polymer film 102 are moved to the inside of the fine water particle generation polymer film 102 through the nano-channels 118. Accordingly, the moisture adsorbed on the surface of the fine water particle generation polymer film 102 are moved to the inside of the fine water particle generation polymer film 102 at high speed due to the moisture concentration difference, and a large amount of moisture can be adsorbed and retained from the air at high speed.

Since moisture is moved using the moisture concentration difference as a drive source in this manner, when an amount of moisture inside the fine water particle generation polymer film 102 is large and an amount of moisture on the surface of the fine water particle generation polymer film 102 is small, that is, when the air is dry, in contrast with the above described moisture adsorption, moisture retained inside the fine water particle generation polymer film 102 is moved at high speed from the inside of the fine water particle generation polymer film 102 to the surface of the fine water particle generation polymer film 102 by the sulfonic acid groups 114a present in the nano-channels 118. That is, the moisture retained inside the fine water particle generation polymer film 102 is moved to the surface of the fine water particle generation polymer film 102 through the nano-channels 118. Accordingly, the moisture retained inside the fine water particle generation polymer film 102 is moved at high speed to the surface of the fine water particle generation polymer film 102 due to the moisture concentration difference, and the fine water particle generation polymer film 102 can release a large amount of moisture to the air at high speed. When humidity of the external air is high, the fine water particle generation polymer film 102 can release a large amount of moisture to the air at high speed by energizing the stainless steel plate 100 to increase the temperature of the fine water particle generation polymer film 102.

Next, the fact that a size of a water particle of the moisture released from the fine water particle generation polymer film 102 in the released state is small will be described. As described above, the particle 110 having a core-shell structure is made of PEDOT/PSS, and the core 112 is made of PEDOT and the shell 114 is made of PSS. PSS has the sulfonic acid groups 114a, which are hydrophilic groups, and is distributed in a large number on an outer surface and inside of the shell 114. Since the fine water particle generation polymer film 102 is formed by stacking the particles 110 having a core-shell structure, the nano-channels 118 having a flow path width of several nanometers are present between a plurality of the adjacent particles 110, and a large number of the sulfonic acid groups 114a are distributed inside the nano-channels 118.

Therefore, inside the nano-channels 118, there are a large number of water clusters of several nanometers obtained by further hydrating water molecules bonded to the sulfonic acid groups 114a.

The reason why several nano-sized water particles are released at the time of moisture release is that when the stainless steel plate 100 is energized, the temperature of the fine water particle generation polymer film 102 is increased and thermal energy is supplied to the water particles. Accordingly, mobility of the water particles increases in the fine water particle generation polymer film 102, and the water clusters present in the nano-channels 118 fly out from a large number of ejection holes present on the surface of the fine water particle generation polymer film 102 corresponding to the nano-channels 118.

It is considered that a water particle diameter of the water particles (moisture) released from the fine water particle generation polymer film 102 is reduced in a process in which a plurality of water molecules gather to form water particles. For example, when there is a substance such as an ion that can be a nucleus of a water particle immediately after water molecules are released from the ejection holes, it is considered that water molecules gather around the ion or the like as the nucleus to form a water particle having a relatively large water particle diameter. However, when the fine water particle generation polymer film 102 is used, there is no generation source of a substance serving as a nucleus of water particles such as ions. Therefore, it is reasonable to consider that, in the fine water particle generation polymer film 102, water molecules present in the nano-channels 118 are less likely to gather even after the water molecules fly out from the surface of the fine water particle generation polymer film 102 due to thermal energy, and a relatively small water particle diameter can be maintained.

As described above, in the fine water particle generation polymer film 102, when the stainless steel plate 100 is in a non-energized state, moisture adsorbed on the surface of the fine water particle generation polymer film 102 is moved to the inside of the fine water particle generation polymer film 102 through the nano-channels 118. Accordingly, the moisture adsorbed on the surface of the fine water particle generation polymer film 102 can be retained inside the fine water particle generation polymer film 102. On the other hand, in the fine water particle generation polymer film 102, when the stainless steel plate 100 is in an energized state, the moisture retained inside the fine water particle generation polymer film 102 is moved to the surface of the fine water particle generation polymer film 102 through the nano-channels 118. Accordingly, the moisture retained inside the fine water particle generation polymer film 102 can be released to the air as fine particles on the surface of the fine water particle generation polymer film 102.

As described above, in the film forming stainless steel plate 108, since the fine water particle generation polymer film 102 is formed on an outer surface of the stainless steel plate 100, when the stainless steel plate 100 is in the non-energized state, the moisture adsorbed on the surface of the fine water particle generation polymer film 102 can be retained inside the fine water particle generation polymer film 102, and when the stainless steel plate 100 is in the energized state, the moisture retained inside the fine water particle generation polymer film 102 can be released to the air as fine particles on the surface of the fine water particle generation polymer film 102. That is, in the film forming stainless steel plate 108, the film forming stainless steel plate 108 having high performance is implemented by forming the fine water particle generation polymer film 102 having high functionality on the outer surface of the stainless steel plate 100.

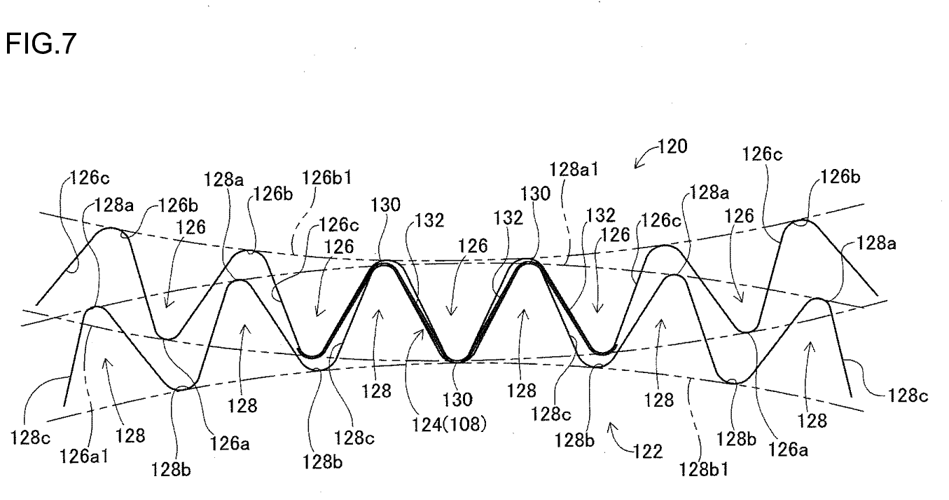

When a corrugated plate is manufactured by a corrugated plate manufacturing device in the related art corrugating the film forming stainless steel plate 108 having the highly functional fine water particle generation polymer film 102 formed on the outer surface, the function of the fine water particle generation polymer film 102 may be deteriorated. Specifically, in the corrugated plate manufacturing device in the related art, as shown in FIG. 7, a pair of gears 120 and 122 mesh with each other, and a corrugated plate 124 is manufactured by causing the film forming stainless steel plate 108 to enter between the pair of meshed gears 120 and 122 and rotating the pair of gears 120 and 122. The gear 120 and the gear 122 have the same shape, and a plurality of teeth 126 formed on an outer peripheral surface of the gear 120 and a plurality of teeth 128 formed on an outer peripheral surface of the gear 122 have the same shape.

The shape of the teeth 126 of the gear 120 and the shape of the teeth 128 of the gear 122 are the same as a shape of the corrugated plate 124. Specifically, the corrugated plate 124 has a plurality of ridge portions 130 formed at an equal pitch. The plurality of ridge portions 130 are end portions in the upper-lower direction of the corrugated plate 124 having a wave shape, and are tip end portions of portions protruding in the upper-lower direction. Pitches formed between a plurality of tooth tips 126a and a plurality of tooth roots 126b of the gear 120 and pitches formed between the tooth tips 128a and tooth roots 128b of the gear 122 are the same as pitches formed between the plurality of ridge portions 130 of the corrugated plate 124. A distance between a tooth tip circle 126a1 of the tooth tip 126a of the gear 120 and a tooth root circle 126b1 of the tooth root 126b of the gear 120 is the same as a height dimension of each of the plurality of ridge portions 130, and a distance between a tooth tip circle 128a1 of the tooth tip 128a of the gear 122 and a tooth root circle 128b1 of the tooth root 128b of the gear 122 is the same as the height dimension of each of the plurality of ridge portions 130. In addition, a shape of a tooth surface 126c between the tooth tip 126a and the tooth root 126b of the gear 120 and a shape of a tooth surface 128c between the tooth tip 128a and the tooth root 128b of the gear 122 are linear shapes and are the same as a shape of a connection portion 132 formed between the two adjacent ridge portions 130 of the corrugated plate 124.

When the film forming stainless steel plate 108 is corrugated by the teeth 126 of the gear 120 and the teeth 128 of the gear 122 having such a shape, the ridge portions 130 are formed by bringing the tooth tip 126a of the gear 120 and the tooth tip 128a of the gear 122 into contact with the film forming stainless steel plate 108. When the gears 120 and 122 rotate, the corrugated plate 124 formed with the ridge portions 130 is conveyed in a rotation direction of the gears 120 and 122, and at this time, the ridge portion 130 of the corrugated plate 124 comes into contact with the tooth root 126b of the gear 120 and the tooth root 128b of the gear 122, and the connection portion 132 of the corrugated plate 124 comes into contact with the tooth surface 126c of the gear 120 and the tooth surface 128c of the gear 122. That is, in a state in which the gears 120 and 122 rotate, the tooth tip 126a of the gear 120 and the tooth tip 128a of the gear 122 come into contact with the ridge portion 130 of the corrugated plate 124, the tooth root 126b of the gear 120 and the tooth root 128b of the gear 122 come into contact with the ridge portion 130 of the corrugated plate 124, and the tooth surface 126c of the gear 120 and the tooth surface 128c of the gear 122 come into contact with the connection portion 132 of the corrugated plate 124.

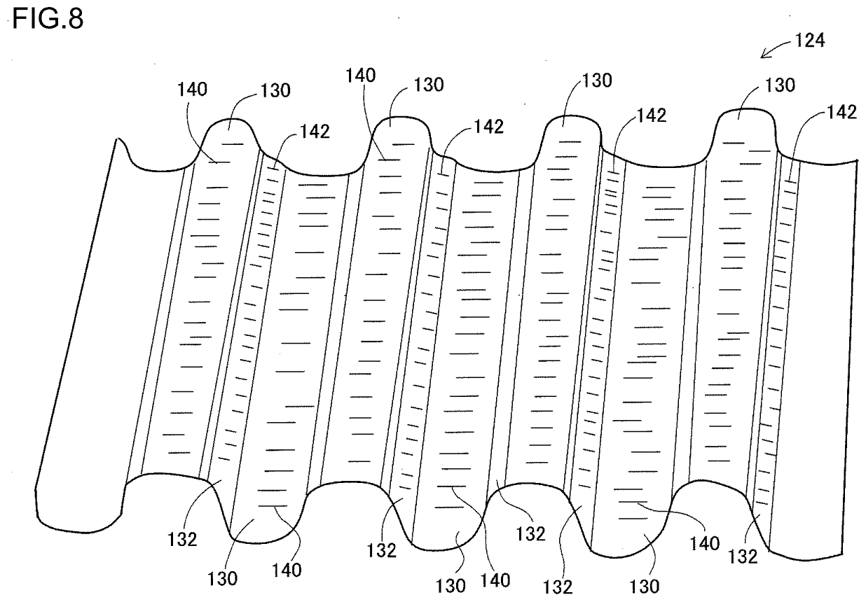

Therefore, as shown in FIG. 8, in the corrugated plate 124, a plurality of scratches 140 are formed on the ridge portion 130 in a manner in which the scratches 140 extend in a rotation direction of the gears 120 and 122, that is, in a direction intersecting a longitudinal direction of the ridge portion 130, and a plurality of scratches 142 are also formed on the connection portion 132. As described above, when the plurality of scratches 140 and 142 are formed on the ridge portion 130 and the connection portion 132 of the corrugated plate 124, the fine water particle generation polymer film 102 formed on the outer surface of the stainless steel plate 100 is scraped, and the function of the fine water particle generation polymer film 102 deteriorates.

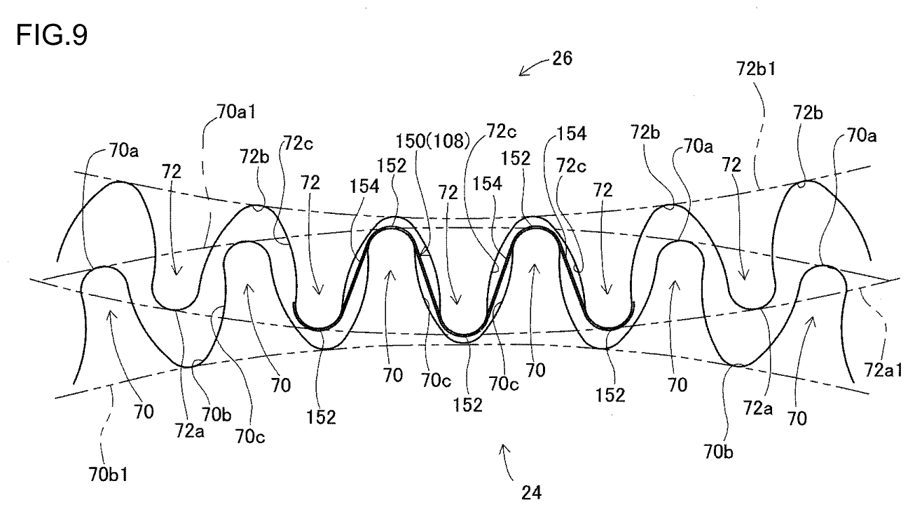

In view of this problem, the plurality of teeth 70 and 72 having the shape shown in FIG. 9 are formed on the pair of gears 24 and 26 of the corrugated plate manufacturing device 10, and a corrugated plate 150 is manufactured by causing the film forming stainless steel plate 108 to enter between the pair of gears 24 and 26 and rotating the pair of gears 24 and 26. The film forming stainless steel plate 108 has a substantially band shape, and the film forming stainless steel plate 108 enters between the pair of gears 24 and 26 in a posture of extending in the longitudinal direction, and the pair of gears 24 and 26 rotate to manufacture the corrugated plate 150 in which a plurality of ridge portions 152 extending in a direction intersecting the longitudinal direction are formed at an equal pitch.

Specifically, a pitch formed between the tooth tip 70a and the tooth root 70b of the gear 24 and a pitch formed between the tooth tip 72a and the tooth root 72b of the gear 26 are the same as a pitch formed between the plurality of ridge portions 152 of the corrugated plate 150. A distance between a tooth tip circle 70a1 of the tooth tip 70a of the gear 24 and a tooth root circle 70b1 of the tooth root 70b of the gear 24 is the same as a height dimension of each of the plurality of ridge portions 152, and a distance between a tooth tip circle 72a1 of the tooth tip 72a of the gear 26 and a tooth root circle 72b1 of the tooth root 72b of the gear 26 is the same as the height dimension of each of the plurality of ridge portions 152. A shape of a tooth surface 70c between the tooth tip 70a and the tooth root 70b of the gear 24 and a shape of a tooth surface 72c between the tooth tip 72a and the tooth root 72b of the gear 26 are curved toward the inside of the teeth 70 and 72, and are curved toward the inside of the teeth 70 and 72 from a shape of a connection portion 154 formed between two of the adjacent ridge portions 152 of the corrugated plate 150.

When the film forming stainless steel plate 108 is corrugated by the teeth 70 of the gear 24 and the teeth 72 of the gear 26 having such a shape, the ridge portions 152 are formed by bringing the tooth tips 70a of the gear 24 and the tooth tips 72a of the gear 26 into contact with the film forming stainless steel plate 108. When the gears 24 and 26 rotate, the corrugated plate 150 formed with the ridge portions 152 is conveyed in a rotation direction of the gears 24 and 26, and at this time, the ridge portions 152 of the corrugated plate 150 come into contact with the tooth root 70b of the gear 24 and the tooth root 72b of the gear 26, but the connection portions 154 of the corrugated plate 150 do not come into contact with the tooth surface 70c of the gear 24 and the tooth surface 72c of the gear 26. That is, in a state in which the gears 24 and 26 rotate, the tooth tip 70a of the gear 24 and the tooth tip 72a of the gear 26 come into contact with the ridge portion 152 of the corrugated plate 150, and the tooth root 70b of the gear 24 and the tooth root 72b of the gear 26 come into contact with the ridge portion 152 of the corrugated plate 150, but the tooth surface 70c of the gear 24 and the tooth surface 72c of the gear 26 do not come into contact with the connection portion 154 of the corrugated plate 150. Therefore, the tooth surface 70c of the gear 24 and the tooth surface 72c of the gear 26 function as non-contact portions that do not come into contact with the connection portion 154 of the corrugated plate 150.

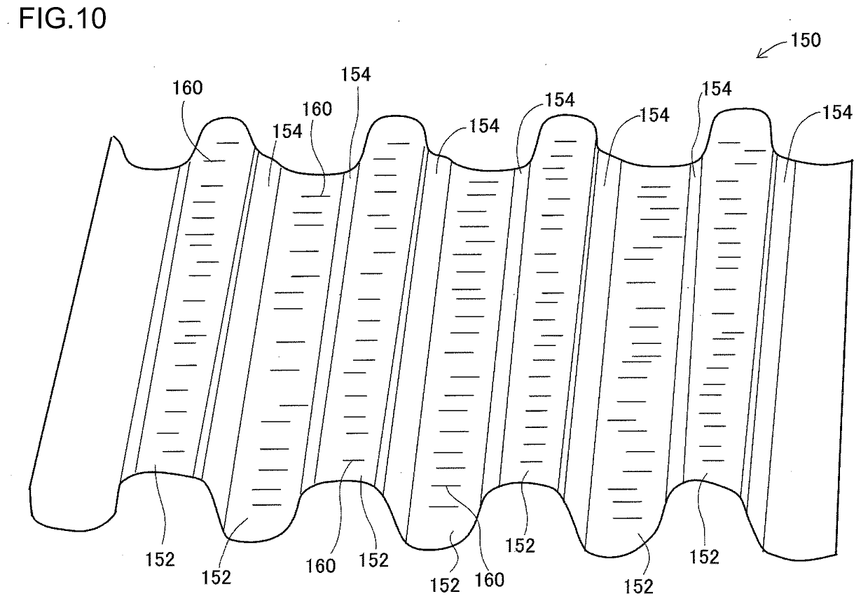

Therefore, as shown in FIG. 10, in the corrugated plate 150, a plurality of scratches 160 are formed on the ridge portion 152 in a manner in which the scratches 160 extend in the rotation direction of the gears 24 and 26, that is, in a direction intersecting a longitudinal direction of the ridge portion 152, but no scratch is formed on the connection portion 154. In this manner, although the plurality of scratches 160 are formed on the ridge portion 152 of the corrugated plate 150, since no scratch is formed on the connection portion 154, it is possible to prevent scraping of the fine water particle generation polymer film 102 formed on the outer surface of the stainless steel plate 100 and prevent the functional deterioration of the fine water particle generation polymer film 102.

In the corrugated plate manufacturing device 10, as described above, when the support shaft 30 is rotated by the rotation of the handle 32, the rotation of the support shaft 30 is transmitted to the support shaft 28 via the transmission mechanism 34, and the support shaft 28 and the support shaft 30 rotate in synchronization with each other. When the support shaft 28 and the support shaft 30 rotate in synchronization with each other and rotate in a state in which the gear 24 and the gear 26 mesh with each other, as shown in FIG. 4, the teeth 70 of the gear 24 and the teeth 72 of the gear 26 do not come into contact with each other. That is, the gear 24 and the gear 26 always rotate independently of each other without coming into contact with each other.

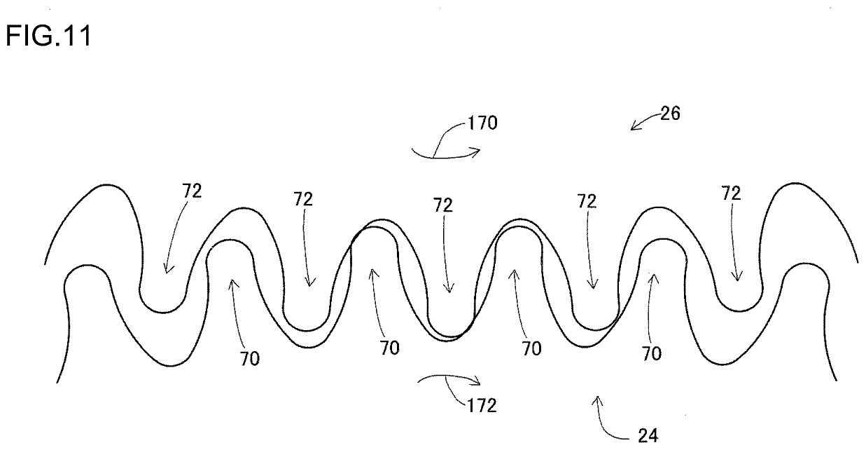

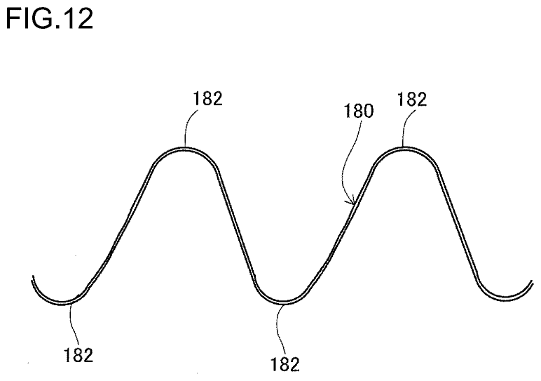

On the other hand, for example, in a corrugated plate manufacturing device without the transmission mechanism 34, when the support shaft 30 is rotated by the rotation of the handle 32, as shown in FIG. 11, the gear 26 fixed to the support shaft 30 is rotated in a direction of an arrow 170. At this time, the teeth 72 of the gear 26 come into contact with the teeth 70 of the gear 24 and press the teeth 70 of the gear 24, thereby rotating the gear 24 in a direction of an arrow 172. That is, in the corrugated plate manufacturing device without the transmission mechanism 34, when the gear 26 is rotated by the rotation of the handle 32, the gear 24 is driven to rotate by the rotation of the gear 26. In this manner, when the corrugated plate manufacturing device in which the gear 24 is rotated by the gear 26 performs corrugating, as shown in FIG. 12, ridge portions 182 of a corrugated plate 180 do not have a symmetrical shape but have a shape biased in a rotation direction of the gears 24 and 26.

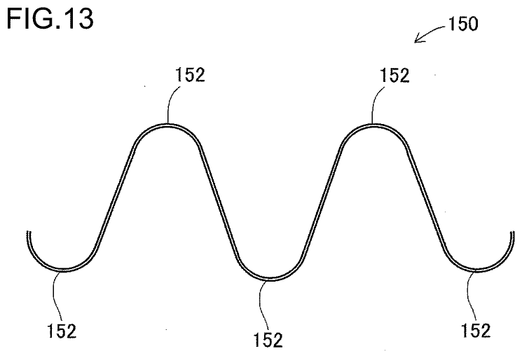

On the other hand, the corrugated plate manufacturing device 10 is provided with the transmission mechanism 34, and the gear 24 and the gear 26 rotate independently of each other without being driven by each other. When the gear 24 and the gear 26 rotate in a meshed state, the teeth 70 of the gear 24 and the teeth 72 of the gear 26 do not come into contact with each other. Therefore, when the corrugated plate manufacturing device 10 performs corrugating, the ridge portions 152 of the corrugated plate 150 have a symmetrical shape as shown in FIG. 13. Accordingly, the corrugated plate 150 having an appropriate shape can be manufactured.

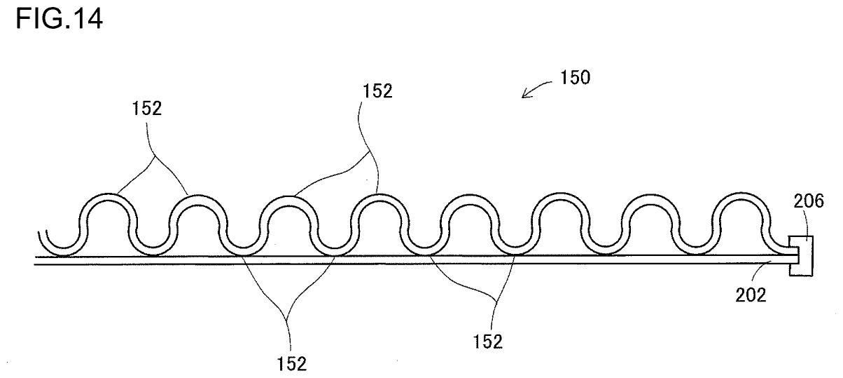

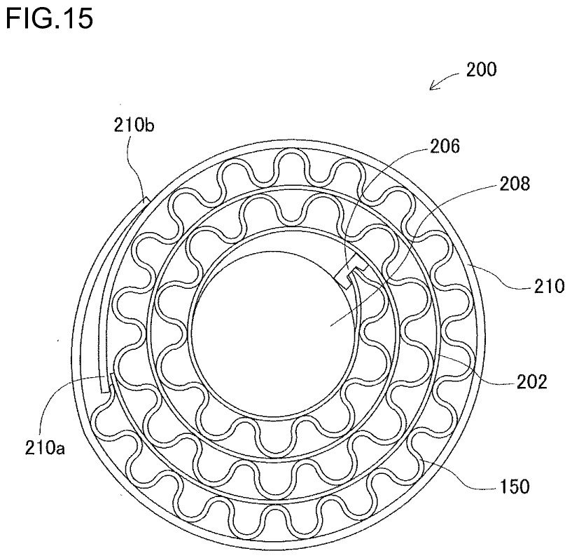

The corrugated plate 150 having the shape shown in FIG. 13 also has high performance of absorbing moisture in the air and releasing the absorbed moisture to the air as fine particles, but in order to exhibit higher performance, the corrugated plate 150 is wound to manufacture a cylindrical shape cartridge (see FIG. 15) 200. Specifically, as shown in FIG. 14, the corrugated plate 150 and an insulating film 202 are integrated by attaching the insulating film 202 to one surface of the corrugated plate 150. Accordingly, tip ends of the ridge portions 152 on the one surface of the corrugated plate 150 and the insulating film 202 are in close contact with each other. An electrode 206 is disposed at one end portion of the corrugated plate 150 and one end portion of the insulating film 202 attached to the corrugated plate 150. Accordingly, the corrugated plate 150 and the insulating film 202 are fixed at the one end portion. The corrugated plate 150 has a band shape, and the insulating film 202 also has a band shape having substantially the same dimension as the corrugated plate 150.

Next, as shown in FIG. 15, the integrated corrugated plate 150 and insulating film 202 are wound around a shaft 208 in a manner of being stacked in a plurality of layers. At this time, the integrated corrugated plate 150 and insulating film 202 are wound such that the corrugated plate 150 is located on an outer side and the insulating film 202 is located on an inner side. Subsequently, one end portion 210a of a stainless steel plate 210 is fixed to an end portion of the corrugated plate 150 located in the outermost layer by welding. Then, the stainless steel plate 210 is wound to cover the corrugated plate 150 of the outermost layer, and another end portion 210b of the stainless steel plate 210 is fixed to an outer peripheral surface of the stainless steel plate 210 by welding. Accordingly, it is possible to prevent the wound corrugated plate 150 and insulating film 202 from being loosened. In this manner, the outermost layer of the wound corrugated plate 150 and insulating film 202 is wound and fixed by the stainless steel plate 210, thereby manufacturing the cylindrical shape cartridge 200. The fine water particle generation polymer film 102 is not formed on the stainless steel plate 210.

In the cartridge 200 manufactured in this manner, the film forming stainless steel plate 108 of the corrugated plate 150 is brought into an energized state by supplying electric power to the electrode 206 and the stainless steel plate 210, and the film forming stainless steel plate 108 of the corrugated plate 150 is brought into a non-energized state by stopping the electric power supply to the electrode 206 and the stainless steel plate 210. Therefore, the moisture adsorbed on the surface of the fine water particle generation polymer film 102 is retained inside the fine water particle generation polymer film 102 by stopping the electric power supply to the electrode 206 and the stainless steel plate 210. On the other hand, the moisture retained inside the fine water particle generation polymer film 102 is released to the air as fine particles on the surface of the fine water particle generation polymer film 102 by supplying electric power to the electrode 206 and the stainless steel plate 210. In the cartridge 200, the corrugated plate 150 and the insulating film 202 are wound in a manner of being stacked in a plurality of layers, but a short circuit is prevented by the insulating film 202 in an energized state of the film forming stainless steel plate 108 of the corrugated plate 150.

When the corrugated plate 150 and the insulating film 202 are attached to each other, tip ends of the ridge portions 152 on one surface of the corrugated plate 150 and the insulating film 202 are in close contact with each other. Tip ends of the ridge portions 152 on the other surface of the corrugated plate 150 and the insulating film 202 are in close contact with each other by winding the corrugated plate 150 and the insulating film 202 in a manner of being stacked in a plurality of layers. That is, in the cartridge 200, the ridge portions 152 of the corrugated plate 150 formed with the scratches 160 are in contact with the insulating film 202. Accordingly, by covering a portion where peeling of the fine water particle generation polymer film 102 occurs with the insulating film 202, it is possible to further prevent the functional deterioration of the fine water particle generation polymer film 102. In the cartridge 200, the corrugated plate 150 having a large surface area can be made compact by winding the band-shaped corrugated plate 150. Accordingly, the cartridge 200 having very high moisture absorption performance and moisture release performance can be made compact.

As described in detail above, the corrugated plate 150 according to the present embodiment includes the fine water particle generation polymer film 102 formed on at least one surface of the stainless steel plate 100, the plurality of ridge portions 152 formed on the stainless steel plate 100 on which the fine water particle generation polymer film 102 is formed, the scratches 160 formed in a direction intersecting the longitudinal direction of the ridge portions 152, and the connection portion 154 formed between two of the adjacent ridge portions 152. The scratches 160 are formed on the ridge portion 152, but no scratch is formed on the connection portion 154. Accordingly, it is possible to prevent functional deterioration of the fine water particle generation polymer film 102.

In the cartridge 200, the insulating film 202 is stacked on the corrugated plate 150. Accordingly, for example, when the corrugated plate 150 is deformed, for example, when the corrugated plate 150 is wound, bent, or curved, it is possible to prevent a short circuit by the insulating film 202 in an energized state of the film forming stainless steel plate 108 of the corrugated plate 150.

The fine water particle generation polymer film 102 includes a polymer film that absorbs and releases moisture due to a temperature change, and the insulating film 202 has electrical insulating properties. Then, temperatures of the corrugated plate 150 and the fine water particle generation polymer film 102 are controlled such that the fine water particle generation polymer film 102 absorbs and releases moisture. Accordingly, it is possible to obtain the cartridge 200 having high moisture absorption performance and moisture release performance.

The corrugated plate manufacturing device 10 includes the gears 24 and 26 that feed the band-shaped stainless steel plate 100 in the longitudinal direction and form the ridge portions 152 extending in the direction intersecting the longitudinal direction, the handle 32 that rotates the gears 24 and 26, and the adjustment mechanism 36 that adjusts the inter-gear distance of the gears 24 and 26. In the corrugated plate manufacturing device 10, the film forming stainless steel plate 108 having various thickness dimensions can be corrugated by adjusting the inter-gear distance. The tooth surfaces 70c and 72c that do not come into contact with the stainless steel plate 100 at the time of manufacturing the corrugated plate 150 are provided between the tooth tips 70a and 72a and the tooth roots 70b and 72b of the gears 24 and 26. Accordingly, it is possible to manufacture the corrugated plate 150 in which no scratch is formed on the connection portion 154, and it is possible to prevent the functional deterioration of the fine water particle generation polymer film 102.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

For example, in the present embodiment, the fine water particle generation polymer film 102 is formed on at least one surface of the stainless steel plate 100, that is, a metal flat plate, and the stainless steel plate 100 on which the fine water particle generation polymer film 102 is formed, that is, the film forming stainless steel plate 108 is corrugated. On the other hand, the fine water particle generation polymer film 102 may be formed on at least one surface of a nonmetallic flat plate, for example, a pulp flat plate, and the pulp flat plate on which the fine water particle generation polymer film 102 is formed may be corrugated. Then, a metal sheet may be attached to the pulp corrugated plate subjected to the corrugating, and the pulp corrugated plate and the metal flat plate may be wound around the shaft 208 to manufacture a cartridge.

In the present embodiment, the fine water particle generation polymer film 102 is formed on the stainless steel plate 100. Alternatively, a polymer film that absorbs and releases moisture due to a temperature change other than the fine water particle generation polymer film 102 may be formed. In addition, the film is not limited to a polymer film that absorbs and releases moisture due to a temperature change, and a film having another function may be formed on the stainless steel plate 100.

In the present embodiment, the cartridge 200, that is, the wound corrugated plate 150 is adopted as the flow path plate. Alternatively, the corrugated plate 150 before being wound, that is, the corrugated plate 150 having a shape shown in FIG. 14 may be adopted as the flow path plate.

Even in a corrugated plate manufacturing device that does not include the transmission mechanism 34, it is possible to manufacture the corrugated plate 150 in which no scratch is formed on the connection portion 154 by performing corrugating using the pair of gears 24 and 26.

According to an aspect of this disclosure, a corrugated plate includes a film portion formed on at least one surface of a flat plate, a plurality of ridge portions formed on the flat plate on which the film portion is formed, a scratch formed in a direction intersecting a longitudinal direction of the ridge portions, and a connection portion formed between two of the adjacent ridge portions. The scratch is formed on the ridge portion and is not formed on the connection portion.

According to another aspect of this disclosure, a flow path plate is formed by stacking a sheet on the corrugated plate.

According to still another aspect of this disclosure, a corrugated plate manufacturing device includes a first roller and a second roller that feed a band-like flat plate in a first direction and form ridge portions extending in a second direction intersecting the first direction, a drive unit configured to rotate the first roller and the second roller, and a control unit configured to adjust a mesh interval between the first roller and the second roller, in which a non-contact portion that does not come into contact with the flat plate during manufacturing a corrugated plate is provided between a tooth tip portion and a tooth root portion of each of the first roller and the second roller.

In the corrugated plate having the above configuration, the scratch is formed on the ridge portion and is not formed on the connection portion. In the flow path plate, the sheet is stacked on the corrugated plate. In the corrugated plate manufacturing device, the non-contact portion that does not come into contact with the flat plate during manufacturing the corrugated plate is provided between the tooth tip portion and the tooth root portion of each of the first roller and the second roller. Accordingly, it is possible to prevent damage to the film portion formed on the surface of the corrugated plate and prevent functional deterioration of the film portion.

What is claimed is:

1. A corrugated plate comprising:
a film portion formed on at least one surface of a flat plate;
a plurality of ridge portions formed on the flat plate on which the film portion is formed;
a scratch formed in a direction intersecting a longitudinal direction of the ridge portions; and
a connection portion formed between two of the adjacent ridge portions, wherein
the scratch is formed on the ridge portion and is not formed on the connection portion.

2. A flow path plate formed by stacking a sheet on the corrugated plate according to claim 1.

3. The flow path plate according to claim 2, wherein
the film portion includes a polymer film that absorbs and releases moisture due to a temperature change,
the sheet is electrically insulating, and
temperatures of the corrugated plate and the film portion are controlled such that the film portion absorbs and releases moisture.

4. A corrugated plate manufacturing device comprising:
a first roller and a second roller that feed a band-shaped flat plate in a first direction and form a ridge portion extending in a second direction intersecting the first direction;
a drive unit configured to rotate the first roller and the second roller; and
a control unit configured to adjust a mesh interval between the first roller and the second roller, wherein
a non-contact portion that does not come into contact with the flat plate during manufacturing a corrugated plate is provided between a tooth tip portion and a tooth root portion of each of the first roller and the second roller.
